(19) United States
(12) Patent Application Publication
(10) Pub. No.: US 2025/0315715 A1
(43) Pub. Date: Oct. 9, 2025

(54) METHOD AND APPARATUS FOR TRAINING A LARGE MODEL USING EDGE COMPUTING DEVICES

(71) Applicant: Uniphore Technologies, Inc., Palo Alto, CA (US)

(72) Inventors: Umesh SACHDEV, Los Altos Hills, CA (US); Balaji RAGHAVAN, Los Altos, CA (US)

(21) Appl. No.: 18/625,934

(22) Filed: Apr. 3, 2024

(51) Int. Cl. G06N 20/00

(52) U.S. Cl. CPC G06N 20/00

(57) ABSTRACT

An apparatus performs a method for training a large model using edge computing devices. The method includes generating one or more training code chunks using a large model, the training code chunks including a component of the large model and a tuning code for the component. The component is individually trainable; generating multiple training data chunks from training data, the training data chunks capable of being processed by the training code chunks on edge nodes, to train the component in the training code chunk; generating a chunk pair including the training code chunk and the training data chunk; sending the chunk pair to an edge node remote to the training controller; receiving a first processed training code chunk from the edge node; and aggregating the first processed training code chunk with at least one second processed training code chunk to generate an updated large model.

### FIELD

This invention relates generally to customer care contact center and other business applications and functions, and more particularly to using distributed processing capability for efficient training of large artificial intelligence (AI) models.

### BACKGROUND

With the proliferation of artificial intelligence (AI) in several aspects of the operation today, there is an ever-increasing demand for high-capacity AI models. Large models are therefore gaining favor, however, training large models, for example, large language models (LLMs) require training such models over billions of parameters, which is computationally intensive, time consuming and costly. There exists a need for resource and time-efficient techniques.

Accordingly, there exists a need for improved techniques for training a large model.

### SUMMARY

The present invention provides a method and an apparatus for training a large model using edge computing devices, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an apparatus for training a large model using edge computing devices, according to some embodiments.

FIG. 2 shows a method for training a large model using edge computing devices, according to some embodiments.

FIG. 3 illustrates an aspect of the subject matter in accordance with one embodiment.

### DETAILED DESCRIPTION

Embodiments of the present invention relate to a method and an apparatus for training a large model using edge computing devices, for example, computers, tablets, smartphones or other smart devices in a computing environment. A large model is configured into individually trainable components, which are combined with tuning code to generate training code chunks capable of individual execution with training data sets to train the components therein. Large training data is split into training data chunks, and a training data chunk is capable of training a component of a training code chunk, on an edge device. Such training code chunk and training data chunk is generated as a chunk pair, which is sent to the edge device for execution, and the edge device may have a particular capacity reserved for such execution. Execution of the chunk pair includes training the component of the training code chunk with the training data chunk using the tuning code, and generating any additional parameters that may be generated optionally as an outcome of the training. The trained component and the optional parameters are referred to as processed training code chunk, which is sent from the edge device to the training controller. The training controller aggregates multiple processed training code chunks, and optionally the additional parameters, if any, received from multiple edge devices into an updated large model, which may then be deployed.

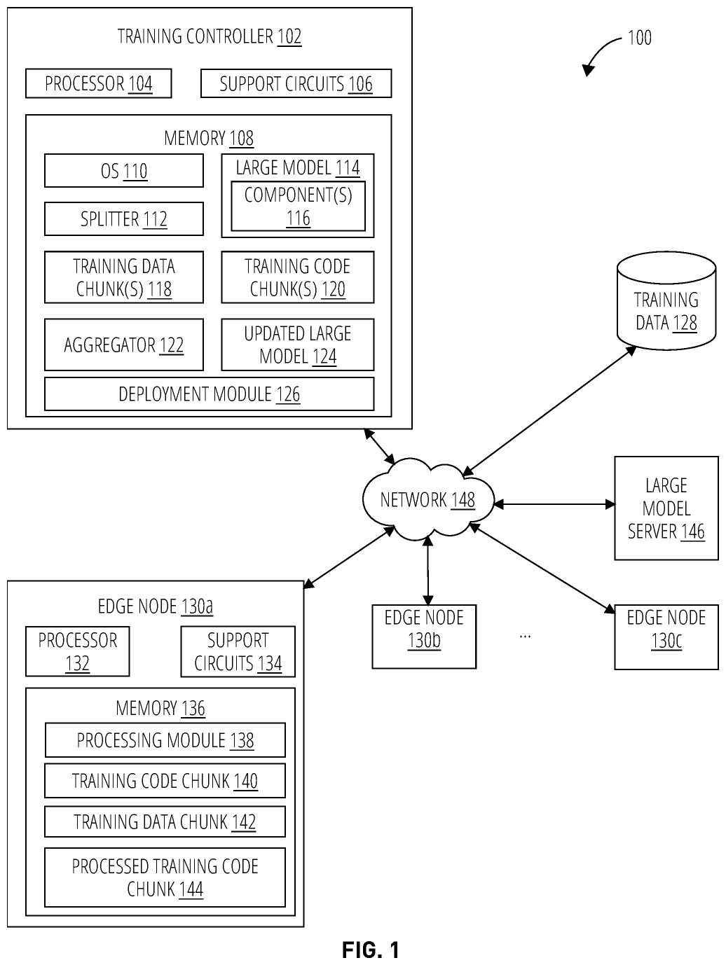

FIG. 1 shows an apparatus 100 for training a large model using edge computing devices, according to some embodiments. The apparatus 100 includes a training controller 102, training data 128, edge nodes 130a, 130b, . . . 130c (may be referred to together by numeral 130), and a large model server 146, each communicably coupled to a network 148.

The training controller 102 includes a processor 104, support circuits 106, and a memory 108. The processor 104 may be any commercially available processor, microprocessor, microcontroller, or similar device. The support circuits 106 include well-known circuits that provide essential functionalities to the processor 104, such as a user interface, clock circuits, network communications, cache, power supplies, I/O circuits, and more. The memory 108 is any form of a digital storage used for storing data and executable software. Such memory includes, but is not limited to, random access memory, read-only memory, disk storage, optical storage, and the like. The memory 108 includes code corresponding to an operating system 110 or OS 110, a splitter 112, a large model 114 which includes component(s) 116, training data chunk(s) 118, training code chunk(s) 120, an aggregator 122, an updated large model 124, and a deployment module 126.

The splitter 112 is configured to generate a training code chunk 120 from a large model, for example the large model 114. In some embodiments, a copy or individually trainable components of the large model is received from the large model server 146. In some embodiments, the training controller 102 has the large model 114 stored thereon from other sources. In some embodiments, the splitter 112 is configured to combine an individually trainable component 116 of the large model 114 with tuning code configured to train the component to generate the training code chunk 120. Individually trainable components include, without limitation, a convolutional layer, a fully-connected layer, a pipeline stage unit, a tensor model unit, a data specific sub-unit, a distilled model, the complete large model, among other sub-units of the large model capable of being trained individually using appropriate training data. In some embodiments, the tuning code is configured to optimize for execution of a particular training data type. In some embodiments, the tuning code is configured to optimize for execution of the component and appropriate training data on an edge node, for example, the edge node 130a. In some embodiments, the tuning code utilizes, without limitation, one or more of tensor model parallelism, pipeline parallelism, transfer learning, tensor decomposition, discriminative fine-tuning, or other techniques as known in the art. The splitter 112 is configured to store a library of tuning code, or access tuning code from a device or service remote to the training controller 102, via the network 148.

The splitter 112 is also configured to generate a training data chunk 118 from training data. In some embodiments, the training data for generating training data chunks 118 is received at the training controller 102 from the training data 128 remote from the training controller 102. In some embodiments, the splitter optimizes splitting of training data for execution with the training code chunk 120. In some embodiments, the splitter 112 optimizes generation of a training data chunk 118 for execution with the training code chunk 120 on an edge node, for example, the edge node 130a. In some embodiments, the splitter splits the training data according to other criteria, for example, uniform data size, uniform number of training parameters, among others known in the art.

The splitter 112 is further configured to generate multiple chunk pairs, each chunk pair including a training code chunk and a training data chunk, for example, as described above. The training code chunk and training data chunk of a chunk pair are executable on an edge node to train the component of the training code chunk using the training data chunk according to the tuning code. The splitter may optimize the generation of one or more of the training code chunk, training data chunk or the chunk pair, for one or more of suitability of training data type of the training data chunk for the component of the training code chunk, computing efficiency of the edge node for executing the training code chunk with the training data chunk, compute time needed to execute the training code chunk with the training data chunk, availability of multiple edge nodes so that multiple processed training data chunks may be aggregated, as discussed below, among other optimization techniques known in the art. In some embodiments, the splitter 112 maintains a table for the edge nodes indicating one or more of the availability of the edge nodes, capability of the edge nodes, or operational history of the edge nodes.

The splitter 112 is configured to send chunk pairs from the training controller 102 to edge nodes, for example, the edge nodes 130a-130c, for execution thereon. In some embodiments, one chunk pair is sent to one edge node, and in some embodiments, multiple chunk pairs are sent to one edge node, for example, according to optimization schemes for execution on edge nodes or aggregation after the execution.

The execution of the training code chunk and the training data chunk on the edge node yields a trained component, and optionally, additional parameters, which are together referred to as a processed training code chunk. Additional parameters include any additional information or code returned along with trained components.

The splitter 112 is configured to receive processed training code chunks, for example, the processed training code chunk 144 at the training controller 102 from the edge nodes 130a-130c. In some embodiments, the splitter 112 verifies that processed training code chunks corresponding to all chunk pairs sent earlier are received. If a processed training code chunk corresponding to a chunk pair is not received from a particular edge node to which the chunk pair was sent, in such embodiments, the splitter 112 sends the chunk pair to the particular edge node or to a different edge node, if the particular edge node repeatedly fails to send back the processed training code chunk.

The aggregator 122 is configured to aggregate multiple processed training code chunks 144 to generate the updated large model 124. For example, the aggregator 122 aggregates the trained components from multiple processed training code chunks, and in some embodiments, the aggregation accounts for the additional parameters in the processed training code chunks 144, if any. The trained components could include parts of the large model, or the entire model. The aggregator 122 aggregates multiple trained components serially or parallelly or both, using techniques known in the art. In some embodiments, the aggregator 122 aggregates the trained components according to one or more techniques such as tensor model parallelism, pipeline parallelism, model distillation, or other techniques as known in the art. The aggregated trained components of the processed training code chunks yield the updated large model 124. The updated large model 124 is the trained version of the large model 114, trained using at least some part of the training data 128.

The deployment module 126 is configured to send the updated large model 124 for deployment, for example, to the large model server 146.

The training data 128 includes large training data sets configured to train the large model. In some embodiments, the training data sets span several billion or trillion training parameters, and may run into several thousands or millions of gigabytes (GBs). The training controller 102 may request training data from the training data 128.

The edge node 130a includes a processor 132, support circuits 134, and a memory 136. The processor 132 may be any commercially available processor, microprocessor, microcontroller, or similar device. The support circuits 134 include well-known circuits that provide essential functionalities to the processor 132, such as a user interface, clock circuits, network communications, cache, power supplies, I/O circuits, and more. The memory 136 is any form of a digital storage used for storing data and executable software. Such memory includes, but is not limited to, random access memory, read-only memory, disk storage, optical storage, and the like. The memory 136 includes code corresponding to an operating system (not shown), a processing module 138, a training code chunk 140, a training data chunk 142, and a processed training code chunk 144.

The processing module 138 receives a chunk pair from the training controller 102. Each chunk pair includes a training code chunk 140, for example, from the training code chunk(s) 120 and a training data chunk 142, for example, from the training data chunk(s) 118 from the training controller 102.

The processing module 138 is configured to execute the training code chunk 140 with the training data chunk 142 to generate a processed training code chunk 144. The execution includes training the component within the training code chunk 140 with the training data chunk 142 to yield a trained component and optionally, any additional parameters yielded by the execution. The trained component and the additional parameters, together, are referred to as the processed training code chunk 144. In embodiments where no additional parameters are generated, the processed training code chunk 144 includes the trained component without any additional parameters.

The processing module 138 is configured to send the processed training code chunk 144 to the training controller 102. In some embodiments, the processing module 138 discards the training data chunk 142 at any time after the execution of the chunk pair utilizing the training data chunk 142. Discarding the training data chunk 142 may be performed due to compliance, to free up space on the memory 136, or as a practice for data security.

In some embodiments, the processing module 138 is configured to operate within a particular percentage of the capacity of the edge device. For example, a predefined capacity of the edge device, such as about 10% to about 15% may be reserved for use by the processing module 138. In some embodiments, a dynamic arrangement may determine the capacity of the edge device available to the processing module. For example, if the edge device is running other processes that are particularly resource intensive, the capacity available to the processing module 138 may be further decreased to 5%, and several such suitable predefined capacity ranges or a dynamic arrangement therefor may be arrived at using techniques as known in the art.

Similar to the edge node 130a, each of the edge nodes 130b-130c include a processor, support circuits, and memory, and each edge node is configured to generate a processed training code chunk. All edge nodes 130a-130c may perform other functions, but have the capability for and are configured to generate to a processed training code chunk.

The large model server 146 is a computing device, as known in the art, on which a large model is deployed. The large model deployed on the large model server 146 includes a base large model, which may be sent to the training controller 102 for being updated, or an updated large model generated by the training controller 102.

The network 148 is a communication network, such as any of the several communication networks known in the art, and for example a packet data switching network such as the Internet, a proprietary network, a wireless GSM network, among others. The network 148 is capable of communicating data to and from the training controller 102, the training data 128, the edge nodes 130, and the large model server 146.

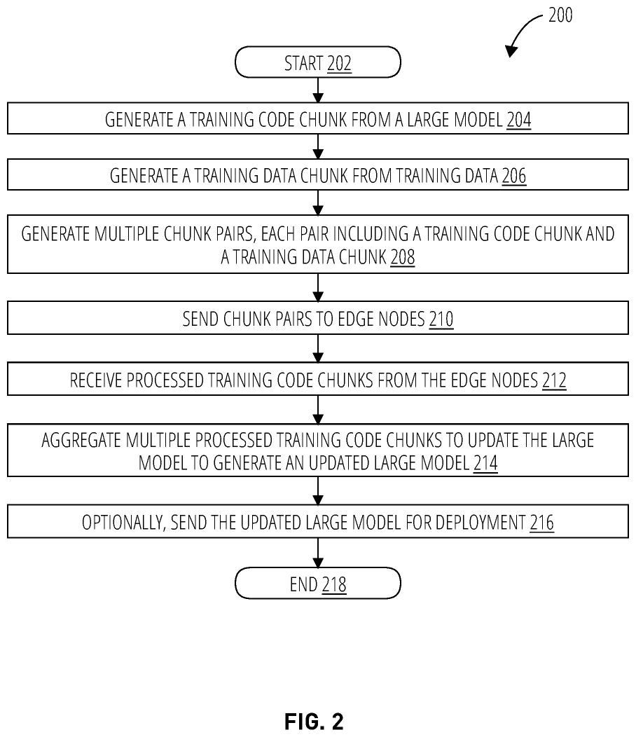

FIG. 2 shows a method 200 for training a large model using edge computing devices, according to some embodiments. In some embodiments, the method 200 is performed by the training controller 102 of FIG. 1.

The method 200 starts at step 202. At step 204, the method 200 generates a training code chunk from a large model, for example the large model 114. In some embodiments, a copy or individually trainable components of the large model are received from the large model server 146 at the training controller 102. In some embodiments, the training controller 102 has the large model 114 stored thereon. In some embodiments, an individually trainable component, for example, the component(s) 116 of the large model, for example the large model 114, is combined with tuning code configured to train the component(s) 116 with training data to generate the training code chunk, for example, the training code chunk(s) 120. Individually trainable components include, without limitation, a convolutional layer, a fully connected layer, a pipeline stage unit, a tensor model unit, a data specific sub-unit, a distilled model, the complete large model, among other sub-units of the large model, capable of being trained individually using appropriate training data. In some embodiments, the tuning code is configured to optimize for execution of a particular training data type. In some embodiments, the tuning code is configured to optimize for execution of the component and appropriate training data on an edge node, for example, the edge node 130a. In some embodiments, the tuning code utilizes, without limitation, one or more of tensor model parallelism, pipeline parallelism, transfer learning, tensor decomposition, discriminative fine-tuning, or other techniques known in the art. In some embodiments, the splitter 112 performs the step 204.

At step 206, the method 200 generates a training data chunk from training data, for example, the training data 128. In some embodiments, the training data 128 is received at the training controller 102, and is split into multiple training data chunks. In some embodiments, the splitting is performed to optimize for execution with the training code chunk generated at step 204. In some embodiments, the splitting is performed to optimize for execution with the training code chunk on an edge node, for example, the edge node 130a. In some embodiments, the splitting is performed according to, for example, uniform data size, uniform number of training parameters, among others known in the art. In some embodiments, the splitter 112 performs the step 206.

At step 208, the method 200 generates multiple chunk pairs, each chunk pair including a training code chunk and a training data chunk, for example, generated at steps 204 and 206 respectively. The training code chunk and training data chunk of a chunk pair are executable on an edge node to train the component of the training code chunk using the training data chunk according to the tuning code. The generation of one or more of training code chunk according to step 204, training data chunk according to step 206, or the chunk pair may be optimized for one or more of suitability of training data type of the training data chunk for the component of the training code chunk, computing efficiency of the edge node for executing the training code chunk with the training data chunk, compute time needed to execute the training code chunk with the training data chunk, availability of multiple edge nodes so that multiple processed training data chunks may be aggregated, as discussed below, among other optimization techniques known in the art. In some embodiments, the splitter 112 performs the step 208.

At step 210, the method 200 sends chunk pairs from the training controller 102 to edge nodes, for example, the edge node 130a-130c, for execution thereon. In some embodiments, the one chunk pair is sent to one edge node, and in some embodiments, multiple chunk pairs are sent to one edge node, for example, according to optimization schemes for execution on edge nodes or aggregation after the execution. In some embodiments, the splitter 112 performs the step 210.

The execution of the training code chunk and the training data chunk on the edge node yields a trained component, and optionally, additional parameters, which are together referred to as a processed training code chunk.

At step 212, the method 200 receives processed training code chunks at the training controller 102 from the edge nodes 130a-130c. In some embodiments, the method 200 verifies that processed training code chunks corresponding to chunk pairs sent at step 210 are received. In some embodiments, a processed training code chunk corresponding to a chunk pair is not received from a particular edge node to which the chunk pair was sent. In such embodiments, the method 200 sends the chunk pair to the particular edge node or a different edge node if the particular edge node repeatedly fails to send back the processed training code chunk. In some embodiments, the splitter 112 performs the step 212.

At step 214, the method 200 aggregates multiple processed training code chunks to generate an updated large model, for example, the updated large model 124. For example, the method 200 aggregates the trained components from multiple processed training code chunks, and in some embodiments, the aggregation accounts for the additional parameters in the processed training code chunks, if any. The trained components could include parts of the large model or the entire model. The aggregation of multiple trained components may be performed serially or parallelly or both, using techniques as known in the art. In some embodiments, the aggregation is performed according to one or more techniques such as tensor model parallelism, pipeline parallelism, model distillation, or other techniques known in the art. The aggregated trained components of the processed training code chunks yield an updated large model. The updated large model is trained version of the large model of step 204, trained using at least some part of the training data. In some embodiments, the aggregator 122 performs the step 214.

At optional step 216, the method 200 sends the updated large model for deployment, for example, to the large model server 146. In some embodiments, the step 216 is performed by the deployment module 126.

The method 200 proceeds to step 218, at which the method 200 ends.

Although the method 200 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

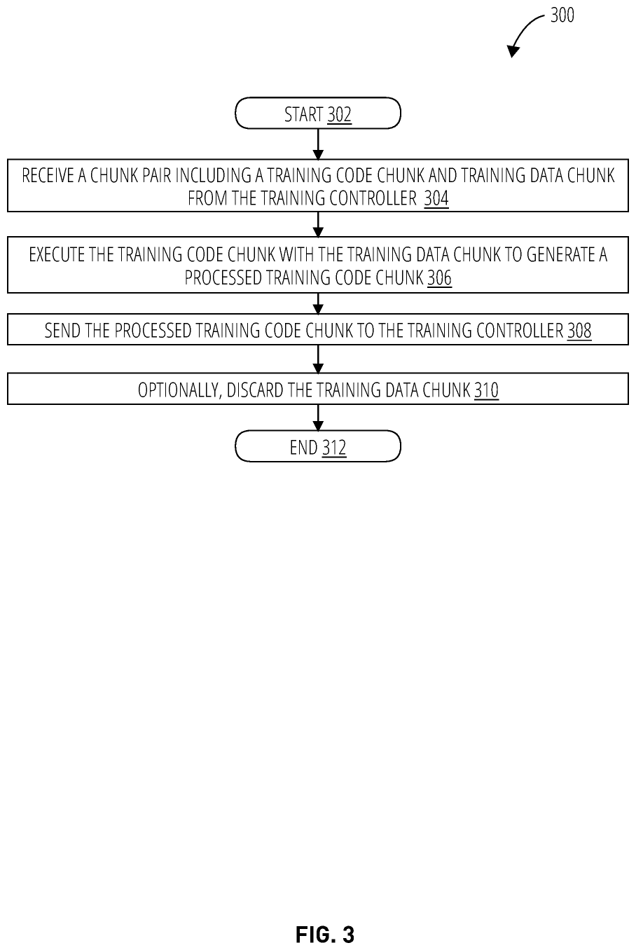

FIG. 3 shows a method 300 for training a large model using edge computing devices, according to an embodiment. In some embodiments, the method 300 is performed by the processing module 138 of the edge node 130a of FIG. 1.

The method 300 starts at step 302, and at step 304, at which the method 300 receives a chunk pair including a training code chunk, for example, the training code chunk 140 and a training data chunk, for example, the training data chunk 142, from a training controller, for example the training controller 102. In some embodiments, the method 300 receives the training code chunk from step 210 of the method 200.

At step 306, the method 300 executes the training code chunk 140 with the training data chunk 142 to generate a processed training code chunk 144. The method 300 trains the component within the training code chunk with the training data chunk to yield a trained component and optionally, any additional parameters, that is, in some embodiments, there would be no additional parameters. The trained component and the additional parameters, together, are referred to as the processed training code chunk. In embodiments where no additional parameters are generated, the processed training code chunk includes the trained component without any additional parameters.

At step 308, the method 300 sends the processed training code chunk 144 to the training controller. In some embodiments, the method 300 sends the processed training code chunk 144 to the step 212 of the method 200.

At optional step 310, the method 300 discards the training data chunk 142 at any time after the execution of the chunk pair at step 306 utilizing the training data chunk 142. Discarding the training data chunk 142 may be performed due to compliance, to free up space, or as a practice for data security.

The method 300 proceeds to step 312, at which the method 300 ends.

Although the method 300 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The large models discussed herein include a large language model (LLM), large multi-modal models (LMM), or other large models as known in the art. Correspondingly, the training data and the tuning code corresponds to a single data mode, for example, text, or multiple data mode, for example, text, audio, pictorial, video, among others.

While thresholds and other metrics may be described qualitatively or using one kind of measures, other known ways of measuring may be employed within the scope of the present invention. Although various methods discussed herein depict a particular sequence of operations, the sequence may be altered without departing from the scope of the present disclosure, unless otherwise apparent from the context. For example, some of the operations depicted may be performed in parallel or in a different sequence that does not materially affect the function of the methods discussed herein. In some embodiments, some of the steps performed in a method may be optional or omitted. In other examples, different components of an example device or apparatus that implements the methods may perform functions at substantially the same time or in a specific sequence.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

While the foregoing is directed to embodiments of the present invention, other and further embodiments of the invention may be devised without departing from the basic scope thereof.

I/We claim:

1. A computer implemented method for training a large model using edge computing devices, the method comprising:
generating, at the training controller, a training code chunk comprising
a component of the large model, wherein the component is individually trainable, and
a tuning code for the large model or the component;
generate, at the training controller, a plurality of training data chunks from training data, at least one training data chunk from the plurality of training data chunks capable of being processed by the training code chunk to train the component;
generating, at the training controller, a chunk pair comprising the training code chunk and the training data chunk;
sending, from the training controller to an edge node remote to the training controller, the chunk pair;
receiving, from the edge node at the training controller, a first processed training code chunk; and
aggregating the first processed training code chunk with at least one second processed training code chunk to generate an updated large model.

2. The computer implemented method of claim 1, further comprising splitting the large model into a plurality of trainable components.

3. The computer implemented method of claim 2, wherein the component comprises at least one of a convolutional layer, a fully-connected layer, a pipeline stage unit, a tensor model unit, a data specific sub-unit, a distilled model, a sub-unit of the large model capable of being trained individually using training data, or the large model.

4. The computer implemented method of claim 3, wherein the aggregating comprises at least one of tensor model parallelism, pipeline parallelism, or model distillation.

5. The computer implemented method of claim 1, wherein the aggregating comprises aggregating the first trained component and the second trained component in series or in parallel.

6. The computer implemented method of claim 1, wherein the generating the chunk pair comprises generating the chunk pair according to at least one of the capability of the edge node or the availability of the edge node.

7. The computer implemented method of claim 1, wherein the tuning code utilizes at least one of tensor model parallelism, pipeline parallelism, transfer learning, tensor decomposition or discriminative fine-tuning.

8. The computer implemented method of claim 1, further comprising, at least one of receiving a copy of the large model deployed on a large model server, or sending the updated large model to a large model server for deployment thereon.

9. A computing apparatus comprising:
a processor; and
a memory storing instructions that, when executed by the processor, configure the apparatus to:
generate, at the training controller, a training code chunk comprising
a component of the large model, wherein the component is individually trainable, and
a tuning code for the large model or the component;
generate, at the training controller, a plurality of training data chunks from training data, at least one training data chunk from the plurality of training data chunks capable of being processed by the training code chunk to train the component;
generate, at the training controller, a chunk pair comprising the training code chunk and the training data chunk;
send, from the training controller to an edge node remote to the training controller, the chunk pair;
receive, from the edge node at the training controller, a first processed training code chunk; and
aggregate the first processed training code chunk with at least one second processed training code chunk to generate an updated large model.

10. The computing apparatus of claim 9, wherein the instructions further configure the apparatus to split the large model into a plurality of trainable components.

11. The computing apparatus of claim 10, wherein the component comprises at least one of a convolutional layer, a fully-connected layer, a pipeline stage unit, a tensor model unit, a data specific sub-unit, a distilled model, a sub-unit of the large model capable of being trained individually using training data, or the large model.

12. The computing apparatus of claim 11, wherein the aggregating comprises at least one of tensor model parallelism, pipeline parallelism, or model distillation.

13. The computing apparatus of claim 9, wherein the aggregate comprises aggregating the first trained component and the second trained component in series or in parallel.

14. The computing apparatus of claim 9, wherein the generate the chunk pair comprises generating the chunk pair according to at least one of the capability of the edge node or the availability of the edge node.

15. The computing apparatus of claim 9, wherein the tuning code utilizes at least one of tensor model parallelism, pipeline parallelism, transfer learn, tensor decomposition or discriminative fine-tuning.

16. A non-transitory computer-readable storage medium, the computer-readable storage medium including instructions that when executed by a computer, cause the computer to:
generate, at the training controller, a training code chunk comprising
a component of the large model, wherein the component is individually trainable, and
a tuning code for the large model or the component;
generate, at the training controller, a plurality of training data chunks from training data, at least one training data chunk from the plurality of training data chunks capable of being processed by the training code chunk to train the component;
generate, at the training controller, a chunk pair comprising the training code chunk and the training data chunk;
send, from the training controller to an edge node remote to the training controller, the chunk pair;
receive, from the edge node at the training controller, a first processed training code chunk; and
aggregate the first processed training code chunk with at least one second processed training code chunk to generate an updated large model.

17. The computer-readable storage medium of claim 16, wherein the instructions further configure the computer to split the large model into a plurality of trainable components, and wherein the at least component from the plurality of components comprises at least one of a convolutional layer, a fully-connected layer, a pipeline stage unit, a tensor model unit, a data specific sub-unit, a distilled model, a sub-unit of the large model capable of being trained individually using training data, or the large model.

18. The computer-readable storage medium of claim 17, wherein the aggregating comprises at least one of tensor model parallelism, pipeline parallelism, or model distillation, or the aggregating comprises aggregating the first trained component and the second trained component in series or in parallel.

19. The computer-readable storage medium of claim 16, wherein the generating the chunk pair comprises generating the chunk pair according to at least one of the capability of the edge node or the availability of the edge node.

20. The computer-readable storage medium of claim 16, wherein the tuning code utilizes at least one of tensor model parallelism, pipeline parallelism, transfer learn, tensor decomposition or discriminative fine-tuning.
